(19) United States
(12) Patent Application Publication
(10) Pub. No.: US 2021/0195918 A1
(43) Pub. Date: Jul. 1, 2021

(54) PACKAGED BEVERAGE AND METHOD FOR PRESERVING KOJI EXTRACT

(71) Applicant: Mugen General Incorporated Association, Kirishima-shi (JP)

(72) Inventor: Masahiro Yamamoto, Kirishima-shi (JP)

(73) Assignee: Mugen General Incorporated Association, Kirishima-shi (JP)

(21) Appl. No.: 17/198,537

(22) Filed: Mar. 11, 2021

Related U.S. Application Data
(63) Continuation of application No. PCT/JP2019/039301, filed on Oct. 4, 2019.

(30) Foreign Application Priority Data
Nov. 8, 2018 (JP) 2018-210292
Jul. 30, 2019 (JP) 2019-139925

(51) Int. Cl. A23L 2/04; A23F 3/16; A23L 2/54; A23L 2/44; A23L 2/84

(52) U.S. Cl. CPC A23L 2/04; A23F 3/16; A23L 2/84; A23L 2/44; A23L 2/54

(57) ABSTRACT

Provided are a packaged beverage containing koji extract in which the generation of old stink is suppressed and the enzyme activity is maintained, and a method for preserving the koji extract. The packaged beverage contains koji extract and has a carbon dioxide gas internal pressure at 20° C. of 0.03 MPa or more.

### TECHNICAL FIELD

The present invention relates to a container-packed beverage containing koji extract and a method for preserving the koji extract.

### BACKGROUND ART

In recent years, the value of traditional Japanese fermented koji foods that use a koji such as sake, shochu, amazake, miso, and soy sauce has been re-recognized, and the popularity of a koji has been increasing. “Koji” means a product obtained by steaming rice, rice bran, barley, bean or the like, and then allowing koji molds to proliferate therein. Among them, koji obtained by allowing koji mold to proliferate in rice is referred to as “rice koji (malted rice)”. Koji molds are known to produce many types of enzymes, by the functions of which fermentation food products can be produced. Research is not limited to this field. The present inventor has conducted researches for finding new functions of koji molds and developing uses based on the functions. Patent Literature 1 reports that a feed obtained by fermenting, e.g., grains, with a koji mold, promotes growth of animals; whereas, Patent Literature 2 reports that a koji fermented composition, which is obtained by inoculating a koji mold into tea leaves and culturing the tea leaves, has an antioxidant activity.

As described above, as a substance from which a koji mold and a fermented product by a koji mold that have various efficacies and the action of promoting health can be ingested, koji extract obtained by extracting a koji with a water-containing solvent, which is referred to as “koji water,” is now attracting attention. Koji water is generally obtained by placing water in a container containing a koji such as rice koji or barley koji and performing extraction for a certain period of time. This koji water contains, in addition to a koji mold itself, various components such as an enzyme produced by the koji mold and a vitamin, an amino acid, glucose, and a polyphenol extracted from rice koji, and is not so different in taste from that of water, and thus can also be drunk as a substitute for water.

### CITATION LIST

### Patent Literature

[Patent Literature 1]

Patent No. 6111416
[Patent Literature 2]

International Publication No. WO 2015/119036

### SUMMARY OF INVENTION

### Technical Problem

It is expected to provide a container-packed beverage containing koji extract so that the above-described koji extract can be easily consumed on a daily basis. Then, when the inventor of the present application conducted research on a packaged beverage containing koji extract, the inventor found the following problem: the water-containing solvent extract of a koji deteriorates with the passage of time and generates an odor similar to old stink (stale odor). Old stink is an unpleasant odor that results from oxidation and degradation occurring during the storage and distribution process of sake, and is a complex odor composed of a plurality of compounds. Therefore, the beverage containing koji extract cannot be prepared and stored, and it is difficult to provide the beverage as a packaged beverage that requires a storage and distribution process.

In addition, as described above, the koji extract contains various enzymes produced by the koji mold, and these enzymes are extremely unstable, and thus the activity of these enzymes in the extract will be lost with the passage of time. Therefore, a problem is that it is difficult to preserve the koji extract for a long period of time while maintaining the enzyme activity.

Therefore, the present invention has been made in view of the above-described points, and an object of the present invention is to provide a packaged beverage containing koji extract in which the generation of old stink is suppressed and the enzyme activity is maintained.

Another object of the present invention is to provide a method for preserving koji extract, that is, a method for suppressing the generation of old stink in the koji extract and a method for maintaining the enzyme activity of the koji extract

### Solution to Problem

In order to solve the above problems, the packaged beverage of the present invention contains koji extract and has a carbon dioxide gas internal pressure at 20° C. of 0.03 MPa or more.

By setting the carbon dioxide gas internal pressure at 20° C. in the packaged beverage to 0.03 MPa or more, the generation of old stink from the koji extract is suppressed. In addition, the activity of enzymes such as protease and glucoamylase derived from the koji extract is stably maintained. Therefore, a beverage containing the koji extract can be provided as a packaged beverage that requires a storage and distribution process. The carbon dioxide gas internal pressure as used herein refers to carbon dioxide gas pressure inside a container, and can be measured using a commercially available gas pressure measuring instrument (gas volume measuring instrument) or the like.

In addition, the koji extract of the packaged beverage of the present invention is preferably water-containing solvent extract of at least one koji selected from the group consisting of rice koji, barley koji and tea koji. Thereby, a suitable raw material for water-containing solvent extract of a koji is selected.

In addition, the above-described packaged beverage is also preferably an alcohol beverage containing an alcohol. The active ingredient contained in the koji extract provides an alcohol carbonated beverage that has the functions of contributing to health improvement and also promoting alcohol metabolism.

In addition, the method for preserving koji extract according to the present invention includes a step of containing carbon dioxide gas in the koji extract such that the carbon dioxide gas internal pressure at 20° C. is 0.03 MPa or more. Thereby, the generation of old stink from the koji extract is suppressed, and the activity of enzymes such as protease and glucoamylase contained in the koji extract is stably maintained, and thus koji extract which does not deteriorate even if prepared and stored is obtained.

In addition, the method for suppressing old stink of the koji extract according to the present invention includes a step of containing carbon dioxide gas in the koji extract such that the carbon dioxide gas internal pressure at 20° C. is 0.03 MPa or more. Thereby, the generation of old stink from the koji extract is suppressed even after preservation in a temperature environment of 25° C. for at least 10 days.

The method for maintaining the enzyme activity of the koji extract according to the present invention includes a step of containing carbon dioxide gas or nitrogen gas in the koji extract such that the internal pressure of carbon dioxide gas or nitrogen gas at 20° C. is 0.03 MPa or more. Thereby, the enzyme activity can be caused to remain even after preservation in a temperature environment of 30° C. for at least 30 days.

Furthermore, in the method for maintaining the enzyme activity of the koji extract according to the present invention, the internal pressure of the carbon dioxide gas or nitrogen gas described above is also preferably 0.1 MPa to 0.15 MPa. Thereby, an enzyme activity that is at least 65% of the initial enzyme activity is maintained even after preservation in a temperature environment of 30° C. for at least 30 days.

### Advantageous Effects of Invention

According to the present invention, a packaged beverage and a method for preserving koji extract having the following excellent effects can be provided.
(1) The generation of old stink from the koji extract can be suppressed.
(2) The activity of the enzymes derived from the koji contained in the koji extract can be maintained.
(3) Because only carbon dioxide gas is contained, the taste does not change and the efficacies of the active ingredients contained in the koji extract are not affected.
(4) Because it is a beverage containing carbon dioxide gas, the beverage has a refreshing taste.

### BRIEF DESCRIPTION OF DRAWINGS

FIG. 1 is a graph illustrating the relationship between the change over time in the enzyme titer in the white koji mold-based rice koji extract in Example 3 and the carbon dioxide gas internal pressure, and (a) a graph about acid protease and (b) a graph about glucose-forming activity (glucoamylase activity and α-glucosidase activity).

FIG. 2 is a graph illustrating the relationship between the change over time in the enzyme titer in the yellow koji mold-based rice koji extract in Example 3 and the carbon dioxide gas internal pressure, and (a) a graph about acid protease and (b) a graph about glucose-forming activity (glucoamylase activity and α-glucosidase activity).

FIG. 3 is a graph illustrating the change over time in the enzyme titer when the white koji mold-based rice koji extract in Example 4 was preserved at a carbon dioxide gas internal pressure of 0.1 MPa, and (a) a graph about acid protease, (b) a graph about glucose-forming activity (glucoamylase activity and α-glucosidase activity), and (c) a graph about xylanase.

FIG. 4 is a graph illustrating the change over time in the enzyme titer when the yellow koji mold-based rice koji extract in Example 4 was preserved at a carbon dioxide gas internal pressure of 0.1 MPa, and (a) a graph about acid protease, (b) a graph about glucose-forming activity (glucoamylase activity and α-glucosidase activity), and (c) a graph about xylanase.

### DESCRIPTION OF EMBODIMENTS

Hereinafter, the present invention will be described in detail.

The koji extract in the present invention refers to extract obtained by immersing a koji in a water-containing solvent, and the koji refers to a product obtained by steaming plant raw material such as rice, barley, a tea leaf, rice bran, and a bean, and then allowing koji molds to proliferate therein. Of these, as the kojis in the present embodiments, rice koji (a product obtained by steaming rice, and then allowing koji molds to proliferate therein), barley koji (a product obtained by steaming barley, and then allowing koji molds to proliferate therein). and tea koji (a product obtained by steaming tea leaf, and then allowing koji molds to proliferate therein) are preferably used. Kojis made using grains such as rice koji and barley koji as raw materials have been conventionally produced and can be produced by a known method. The tea koji is a koji developed by the inventor of the present application, and can be produced by, for example, the method disclosed in Patent Literature 2. Specifically, without particular limitation, and the tea koji can be obtained by adding water to a raw tea leaf such that the water content of the raw tea leaf is about 50% to perform water absorption treatment, then placing the tea leaf in a drum-type koji making apparatus to perform steaming treatment (at 95° C. for about 60 minutes) and cooling to 30° C., then adding a seed koji (2 billion spores/1 g of seed koji) of a koji mold such as Aspergillus awamori var. kawachii to the tea leaf in such a way as to provide 0.1% by weight and mix them, and making the koji in the drum-type koji making apparatus for 3 days.

In the present invention, the type of a koji mold propagated in a koji is not limited, any koji mold commonly used in the field of a koji fermentation food can be used, and for example, a white koji mold, a black koji mold, or a yellow koji mold are used. Of these, the white koji mold refers to a group of molds of belonging to the genus Aspergillus that form a white ocher-colored conidium (a kind of asexual spore) and used for producing shochu, and examples of typical fungal species thereof include Aspergillus kawachii. In addition, the black koji mold refers to a group of molds belonging to the genus Aspergillus that form a black or black-brown conidium used in the production of a distilled liquor such as Okinawa awamori and Kagoshima potato shochu. Specific examples include, but are not particularly limited to, Aspergillus awamori var. kawachii (kawachii black koji mold), Aspergillus luchuensis, Aspergillus awamori, Aspergillus saitoi, Aspergillus inuii, Aspergillus usamii, and Aspergillus aureus. Furthermore, the yellow koji mold refers to a group of molds belonging to the genus Aspergillus that form a yellow or yellow-green conidium mainly used in the production of sake, miso, soy sauce, and the like, and examples of typical fungal species thereof include Aspergillus oryzae and Aspergillus sojae.

The koji extract is obtained by immersing the above-described koji in a water-containing solvent, and in the present invention, is preferably one obtained by adding the koji at a ratio of 1 g to 500 g per 1000 mL of the water-containing solvent followed by extraction: and if the amount of the koji is too large, the aroma of the koji itself may be strongly felt, and thus the koji extract is more preferably one obtained by adding the koji at a ratio of 10 g to 300 g followed by extraction. in addition, the water-containing solvent in the present invention means a solvent containing at least water, and is preferably a solvent mainly composed of water, and also include a solvent containing not only water but also another component blended in water by dissolution or mixing. Without particular limitation, water containing tea (tea leaf extract such as green tea), an alcohol such as a distilled liquor, a brewed liquor and ethanol, a fruit juice, a vitamin, an inorganic salt, a sugar, or the like may be used as the water-containing solvent.

For the extraction time for producing the koji extract, the suitable time varies depending on the extraction temperature, and the koji extract is preferably one obtained by extraction in a water-containing solvent for about 1 hour to 5 days under a temperature condition of a room temperature of 25° C. or less, more preferably one obtained by extraction for about 2 hours to 3 days, and more preferably one obtained by extraction for about 3 hours to 12 hours. For the extraction temperature, in order not to lose the activity of an active ingredient such as an enzyme contained in the koji, the koji extract is more preferably one obtained by extraction at more than 0° C. and less than 40° C., and further preferably one obtained by extraction at 2° C. or more and 30° C. or less.

In addition, in the above-described extraction step, fermentation by a koji mold in a water-containing solvent may be performed. Without particular limitation, for example, when water containing green tea extract (so-called green tea beverage) is added as a water-containing solvent to rice koji using. Aspergillus kawachii, and the rice koji is soaked and subjected to extraction for about 3 days in a temperature environment of 10 to 20° C., fermentation by the rice koji occurs. By this extraction and fermentation step, the aroma of the green tea beverage is lost, but the polyphenol derived from green tea remains in the koji extract, and thus koji extract having a refreshing acidity and richness is obtained.

When collecting the koji extract after the extraction treatment, filtration treatment is preferably performed in order to separate the soaked koji and the koji extract, In addition, in order to remove a microorganism such as the koji mold from the collected koji extract, aseptic filtration treatment is more preferably performed. This eliminates the need, for high-temperature sterilization treatment, and thus the components extracted from the koji are contained in the koji extract without denaturation or deterioration. Of course, the aseptic filtration treatment can also be performed after a gas is injected under pressure into the koji extract.

In the present invention, the carbon dioxide gas internal pressure in the koji extract or the beverage containing the koji extract as described above is adjusted such that the carbon dioxide gas internal pressure at 20° C. is 0.03 MPa or more. This allows suppression of the generation of old stink from the koji extract. The carbon dioxide gas internal pressure refers to carbon dioxide gas pressure inside a container, and can be measured using a commercially available gas pressure measuring instrument (gas volume measuring instrument) or the like. The carbon dioxide gas internal pressure is preferably adjusted to 0.03 MPa or more, and more preferably adjusted to 0.05 MPa or more. A method for adjusting the carbon dioxide gas internal pressure, that is, a method for containing carbon dioxide gas in koji extract or a beverage containing the koji extract, is not particularly limited as long as it can adjust the carbon dioxide gas internal pressure using any known method or a known carbonator. An example thereof is a method for pressurizing and dissolving carbon dioxide gas in koji extract or the like using a carbonated water maker, and by mixing a material containing carbon dioxide gas such as carbonated water into koji extract or a beverage containing the koji extract, the carbon dioxide gas internal pressure can also be adjusted.

In addition, in the present invention, by adjusting the carbon dioxide gas internal pressure in the koji extract or the beverage containing the koji extract as described above such that the carbon dioxide gas internal pressure at 20° C. is 0.03 MPa or more, the activity of the enzymes derived from the koji contained in the koji extract can be maintained. Specifically, the enzyme activity contained in the koji extract can be caused to remain even after preservation in a temperature environment of 30° C. for at least 30 days. The carbon dioxide gas internal pressure is preferably adjusted to 0.03 MPa or more, and more preferably adjusted to 0.1 MPa to 0.15 MPa or less, from the viewpoint of the effect of causing the enzyme activity to remain. In addition, the same effect of maintaining the enzyme activity can also be obtained using nitrogen gas instead of the carbon dioxide gas described above.

In the present invention, the enzyme whose activity is maintained in koji extract or a beverage containing the koji extract is an enzyme derived from a koji mold or a koji, and examples thereof include, but are not particularly limited to, α-amylase, α-glucosidase, β-glucosidase, glucoamylase, an enzyme group exhibiting saccharifying power (glucoamylase+α-glucosidase), acid protease, acid carboxypeptidase, a hemicellulase such as xylanase, cellulase, and lipase.

In addition, the beverage containing koji extract whose carbon dioxide gas internal pressure is adjusted may contain components other than the koji extract. Examples of the other components include, but are not particularly limited to, a sweetener such as a sugar, an acidulent, a fruit juice, a plant extract, tea extract, a milk component, a flavor, a vitamin, and a coloring agent. After these other components are blended in the koji extract, the carbon dioxide gas internal pressure is adjusted such that the carbon dioxide gas internal pressure at 20° C. is 0.03 MPa or more as described above, and thereby the generation of old stink from the beverage containing the koji extract can be suppressed, and the activity of the enzymes contained in the koji extract is also stably maintained.

In addition, the beverage containing the koji extract whose carbon dioxide gas internal pressure is adjusted may contain an alcohol. As the alcohol, either of a distilled liquor and a brewed liquor can be used, and without particular limitation, shochu such as potato shochu and awamori, sake, an alcohol for a raw material, gin, whiskey, brandy, spirit, and the like can be used. After the alcohol or the like is blended in the koji extract, the carbon dioxide gas internal pressure is adjusted such that the carbon dioxide gas internal pressure at 20° C. is 0.03 MPa or more as described above, and thereby the generation of old stink from the alcohol beverage containing the koji extract can be suppressed, and the activity of the enzymes contained in the koji extract is also stably maintained. The alcohol content of the alcohol beverage is not particularly limited, and if the alcohol content is adjusted to less than 10 v/v %, a refreshing highball-like koji water alcohol beverage can be obtained.

The packaged beverage containing the koji extract according to the present invention is not particularly limited as long as the container is fillable and sealable, and is provided by filling a container such as a PET bottle, a metal can, or a bottle with the koji extract.

Next, the present invention will be described in more detail with reference to Examples, but the present invention is not limited at all by these Examples.

### EXAMPLES

### Example 1

1. Suppression of the Generation of Old Stink from the Koji Extract by Adjusting the Carbon Dioxide Gas Pressure

Rice koji of a white koji mold (Aspergillus kawachii) was added at a ratio of 200 g per L of water, and the mixture was subjected to extraction under a condition of 30° C. for 10 hours. The supernatant was collected and aseptically filtered to obtain water extract of the koji used in the following Examples and the Comparative Example. The water extract of the koji was mixed with various alcohols to obtain beverage samples (test groups A to D) shown in Table 1 below.

TABLE 1

| Test group No. | Blend formulation |
|---|---|
| Test group A (alcohol | Water extract of the koji 1 L |
| content of 7%) | Shochu having an alcohol |
| | content of 40% 212 mL |
| Test group B (alcohol | Water extract of the koji 1 L |
| content of 7%) | Sake having an alcohol |
| | content of 14% 1 L |
| Test group C (alcohol | Water extract of the koji 1 L |
| content of 7%) | Whisky having an alcohol |
| | content of 43% 194 mL |
| Test group D (no alcohol) | Water extract of the koji alone |

Carbon dioxide gas was injected under pressure into the four beverage samples of test groups A to D shown in Table 1 such that the carbon dioxide gas internal pressure in the container at 20° C. was 0.1 MPa, and 100-mL aluminum cans, respectively, were filled with the samples. The carbon dioxide gas internal pressure in the containers was confirmed by measuring the gas pressure of the beverage samples with which the cans were filled to be stoppered immediately after carbonation. The four aluminum canned beverage samples whose carbon dioxide gas internal pressure was adjusted to 0.1 MPa were allowed to stand in an environment of 25° C., and sensory evaluation was performed on the old stink or old stink-like odors generated from the beverages containing the water extract of the koji every day for 10 days. The sensory evaluation was performed by 10 panelists who were engaged in sake brewing at sake breweries and were familiar with old stink and old stink-like odors. The reason for the sensory evaluation is that some various components of the old stink are specified, but the old stink is a complex odor in which various components are mixed, and the components have not been clearly determined yet, and thus the sensory evaluation was based on the human sense of smell. The details of the 10 panelists are shown in Table 2, and results of the sensory evaluation are shown in Table 3.

TABLE 2

| Age | No. of Males | No. of Females |
|---|---|---|
| 20 s | 2 | 1 |
| 30 s | 1 | 3 |
| 40 s | 1 | 1 |
| 60 s | 1 | — |

TABLE 3

| Number | | | | |
|---|---|---|---|---|
| of days | Test | Test | Test | Test |
| elapsed | group A | group B | group C | group D |
| 1 day | 0 | 0 | 0 | 0 |
| 2 days | 0 | 0 | 0 | 0 |
| 3 days | 0 | 0 | 0 | 0 |
| 4 days | 0 | 0 | 0 | 0 |
| 5 days | 0 | 0 | 0 | 0 |
| 6 days | 0 | 0 | 0 | 0 |
| 7 days | 0 | 0 | 0 | 0 |
| 8 days | 0 | 0 | 0 | 0 |
| 9 days | 0 | 0 | 0 | 0 |
| 10 days | 0 | 0 | 0 | 0 |

As shown in Table 3, no generation of old stink was observed in any of the canned beverages containing the water extract of the koji.

### Comparative Example

2. Generation of Old Stink from Koji Extract

Using the water extract of the koji produced in the same manner as in Example 1 described above, the water extract of the koji was mixed with various alcohols to obtain beverage samples (control groups A to D) shown in Table 4 below.

TABLE 4

| Test group No. | Blend formulation |
|---|---|
| Control group A (alcohol | Water extract of the koji 1 L |
| content of 7%) | Shochu having an alcohol |
| | content of 40% 212 mL |
| Control group B (alcohol | Water extract of the koji 1 L |
| content of 7%) | Sake having an alcohol |
| | content of 14% 1 L |
| Control group C (alcohol | Water extract of the koji 1 L |
| content of 7%) | Whisky having an alcohol |
| | content of 43% 194 mL |
| Control group D (no | Water extract of the koji alone |
| alcohol) | |

100-mL aluminum cans were directly filled with the respective four beverage samples of control groups A to D shown in Table 4. The four aluminum canned beverage samples were allowed to stand in an environment of 25° C., and sensory evaluation was performed on the old stink or old stink-like odors generated from the beverages containing the water extract of the koji every day for 10 days in the same manner as in Example 1. The 10 panelists in charge were the same persons as in Example 1. Results of the sensory evaluation are shown in Table 5.

TABLE 5

| Number | Control | Control | Control | Control |
|---|---|---|---|---|
| of days | group | group | group | group |
| elapsed | A | B | C | D |
| 1 day | 0 | 0 | 0 | 0 |
| 2 days | 0 | 0 | 0 | 0 |
| 3 days | 1 | 3 | 0 | 2 |
| 4 days | 3 | 3 | 0 | 5 |
| 5 days | 7 | 6 | 2 | 8 |
| 6 days | 10 | 7 | 3 | 10 |
| 7 days | 10 | 8 | 5 | 10 |
| 8 days | 10 | 10 | 8 | 10 |
| 9 days | 10 | 10 | 8 | 10 |
| 10 days | 10 | 10 | 8 | 10 |

As shown in Table 5, from the canned beverages containing the water extract of the koji after 3 days elapsed, the generation of old stink was observed, and from the beverage sample of the water extract of the koji alone (control group D), old stink was generated after 4 days elapsed according to the evaluation by 50% of the panelists, and old stink was generated after 6 days elapsed according to the evaluation by all the panelists (100%). In addition, in the beverage samples containing an alcohol (control groups A to C), the generation of old stink was observed as in the beverage sample containing no alcohol (control group D). Although the water extract of the koji has an antioxidant activity derived from the koji, old stink was generated as described above, and thus it was considered that the old stink is not necessarily generated by the oxidative action.

### Example 2

3. Discussion of Carbon Dioxide Gas Pressure

Water extract of the koji was produced in the same manner as in Example 1 to obtain the same beverage samples (test groups A to D) shown in Table 1. Carbon dioxide gas was injected under pressure into the four beverage samples of test groups A to D shown in Table 1 such that the carbon dioxide gas internal pressure in the container at 20° C. was 0.01 MPa, 0.03 MPa, 0.05 MPa, 0.1 MPa, or 0.2 MPa, and 100-mL aluminum cans, respectively, were filled with the samples. The carbon dioxide gas internal pressure in the containers was confirmed by measuring the gas pressure of the beverage samples with which the cans were filled to be stoppered immediately after carbonation. The four aluminum canned beverage samples, each adjusted such that the carbon dioxide gas internal pressure was a predetermined pressure, were allowed to stand in an environment of 25° C. for 10 days. After 10 days, sensory evaluation was performed on the old stink or old stink-like odors generated from the beverages containing the water extract of the koji in the same manner as in Example 1 and the Comparative Example. The 10 panelists in charge were the same persons as in Example 1 and the Comparative Example. Results of the sensory evaluation are shown in Table 6.

TABLE 6

| Carbon dioxide | | | | |
|---|---|---|---|---|
| gas internal | Test | Test | Test | Test |
| pressure | group A | group B | group C | group D |
| 0.01 MPa | 7 | 8 | 7 | 8 |
| 0.03 MPa | 0 | 0 | 0 | 0 |
| 0.05 MPa | 0 | 0 | 0 | 0 |
| 0.1 MPa | 0 | 0 | 0 | 0 |
| 0.2 MPa | 0 | 0 | 0 | 0 |

As shown in Table 6, when the carbon dioxide gas internal pressure was 0.01 MPa, the generation of old stink was observed from the canned beverages containing the water extract of the koji, but no generation of old stink was observed from the beverages in which the carbon dioxide gas internal pressure was adjusted to 0.03 MPa. From the foregoing, it was found that by adjusting the carbon dioxide gas internal pressure to 0.03 MPa or more, the generation of old stink from a beverage containing the water extract of the koji can be suppressed, and the beverage can be preserved in a drinkable state for a long period of time.

### Example 3

4. Effect of Maintaining Enzyme Activity Contained in Koji Extract by Adjusting Carbon Dioxide Gas Pressure (1)

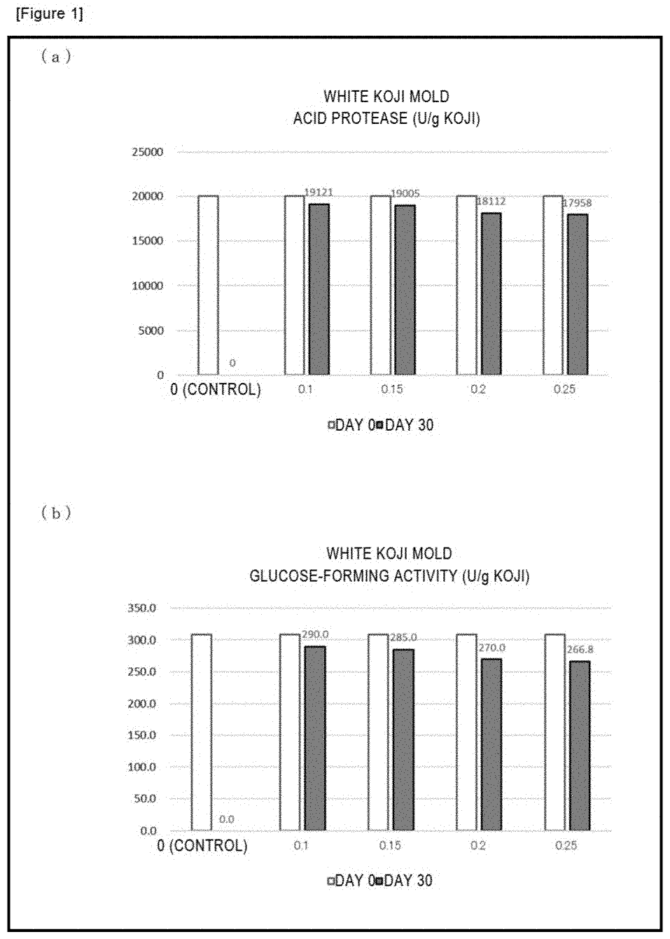

Rice koji obtained by propagating a white koji mold (Aspergillus kawachii) on rice was added at a ratio of 30 g per 100 mL of water, and the mixture was subjected to extraction under a condition of 30° C. for 3 hours. The supernatant was collected and aseptically filtered through a sterilization filter to obtain water extract of the koji. The enzyme titers of acid protease and glucose-forming activity (glucoamylase activity+α-glucosidase activity) contained in the freshly obtained koji extract were measured as the enzyme activity on day 0. Carbon dioxide gas was injected under pressure into the water extract of the koji such that the carbon dioxide gas internal pressure in the container at 20° C. was 0.1 MPa, and with the extract a 100-mL aluminum can was filled to prepare a test sample. The carbon dioxide gas internal pressure in the container was confirmed by measuring the gas pressure of the koji extract with which the can was filled to be stoppered immediately after carbonation. Furthermore, carbon dioxide gas was injected under pressure into the water extracts of the koji obtained in the same manner such that the carbon dioxide gas internal pressures in the container at 20° C. were 0.15 MPa, 0.2 MPa, and 0.25 MPa, respectively, and 100-mL aluminum cans, respectively, were filled with the extracts to prepare test samples. Furthermore, for comparison and as a control, a 100-mL aluminum can was directly filled with the water extract of the koji obtained in the same manner to prepare a control sample (carbon dioxide gas internal pressure of 0 MPa). The five aluminum canned samples, each adjusted such that the carbon dioxide gas internal pressure was a predetermined pressure, were allowed to stand in an environment of 30° C. for 30 days. After 30 days, the aluminum cans were opened, and the enzyme titers of acid protease and glucose-forming activity contained in the water extract of the koji were measured as the enzyme activity on day 30. Results are shown in Table 7, Table 8, and FIG. 1.

The enzyme titers of acid protease and glucose-forming activity (glucoamylase activity+α-glucosidase activity) were measured according to the method of the National Research. Institute of Brewing standard analysis method (solid koji; National Research Institute of Brewing, an independent administrative agency).

TABLE 7

| | Carbon dioxide | | | Day 30 |
|---|---|---|---|---|
| | gas internal | Day 0 | Day 30 | Enzyme activity |
| | pressure (MPa) | (U/g koji) | (U/g koji) | remaining rate |
| Acid | 0 (Control) | 20051.2 | 0.0 | 0.0% |
| protease | 0.1 | | 19120.5 | 95.4% |
| (white | 0.15 | | 19005.0 | 94.8% |
| koji | 0.2 | | 18112.0 | 90.3% |
| mold) | 0.25 | | 17958.1 | 89.6% |

TABLE 8

| | Carbon dioxide | | | Day 30 |
|---|---|---|---|---|
| | gas internal | Day 0 | Day 30 | Enzyme activity |
| | pressure (MPa) | (U/g koji) | (U/g koji) | remaining rate |
| Glucose | 0 (Control) | 308.2 | 0.0 | 0.0% |
| forming | 0.1 | | 290.0 | 94.1% |
| activity | 0.15 | | 285.0 | 92.5% |
| (white | 0.2 | | 270.0 | 87.6% |
| koji | 0.25 | | 266.8 | 86.6% |
| mold) | | | | |

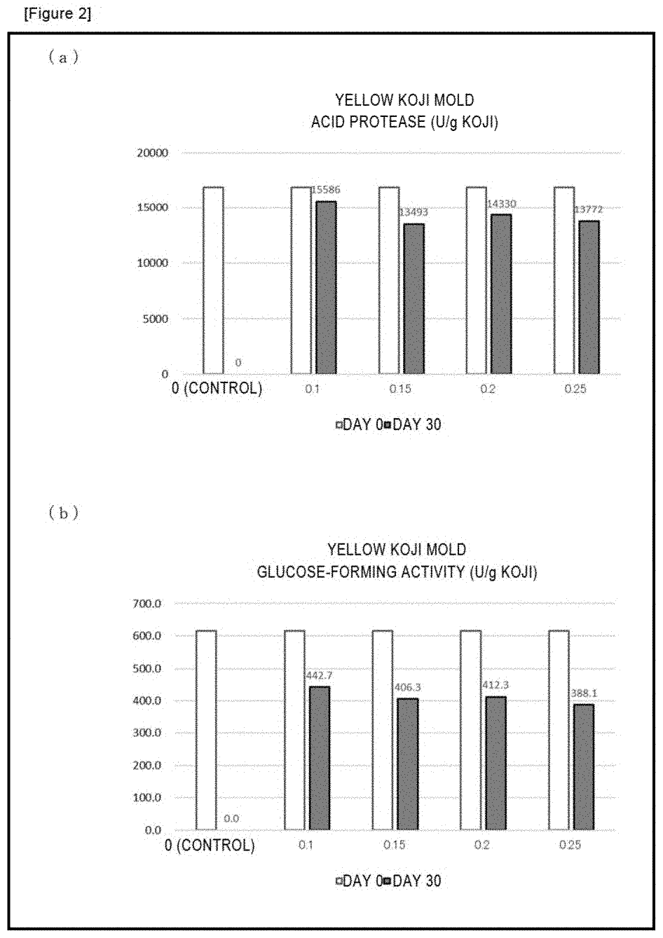

The water extract of the koji obtained using the rice koji obtained by propagating a yellow koji mold (Aspergillus oryzae) on rice as the rice koji was also measured for the enzyme activity of acid protease and glucose-forming activity using the same conditions and methods as described above. Results thereof are shown in Table 9, Table 10, and FIG. 2.

TABLE 9

| | Carbon dioxide | | | Day 30 |
|---|---|---|---|---|
| | gas internal | Day 0 | Day 30 | Enzyme activity |
| | pressure (MPa) | (U/g koji) | (U/g koji) | remaining rate |
| Acid | 0 (Control) | 16841.9 | 0.0 | 0.0% |
| protease | 0.1 | | 15586.0 | 92.5% |
| (yellow | 0.15 | | 13493.0 | 80.1% |
| koji | 0.2 | | 14330.2 | 85.1% |
| mold) | 0.25 | | 13772.1 | 81.8% |

TABLE 10

| | Carbon dioxide | | | Day 30 |
|---|---|---|---|---|
| | gas internal | Day 0 | Day 30 | Enzyme activity |
| | pressure (MPa) | (U/g koji) | (U/g koji) | remaining rate |
| Glucose | 0 (Control) | 615.2 | 0.0 | 0.0% |
| forming | 0.1 | | 442.7 | 72.0% |
| activity | 0.15 | | 406.3 | 66.0% |
| (yellow | 0.2 | | 412.3 | 67.0% |
| koji | 0.25 | | 388.1 | 63.1% |
| mold) | | | | |

As shown in FIGS. 1 and 2 and Tables 7 to 10 it was confirmed that various enzyme activities remained in the water extract of the koji into which carbon dioxide gas was injected under pressure even after preservation in an environment of 30° C. for 30 days. According to this result, it was found that by injecting carbon dioxide gas under pressure into the water extract of the koji such that the carbon dioxide gas internal pressure at 20° C. was 0.1 to 0.25 MPa, at least more than 60% of the enzyme titer can be maintained even after preservation in an environment of 30° C. for 30 days. At this time, the enzyme activity of the water extract of the koji into which carbon dioxide gas was not injected under pressure, which was a comparative control, was zero and completely lost. In addition, according to these results, it was found that the enzyme titer tends to decrease slightly as the carbon dioxide gas internal pressure becomes higher than a predetermined pressure. This indicated that the carbon dioxide gas internal pressure of the water extract of the koji for maintaining the enzyme activity is preferably adjusted to 0.1 MPa to 0.15 MPa, and that thereby even after preservation for at least 30 days in a temperature environment of 30° C., an enzyme titer that is at least 66% or more of the initial enzyme activity is maintained. In addition, in the present Example, carbon dioxide gas was injected under pressure into the water extract of the koji, but it has been confirmed that the same effect of maintaining the enzyme activity can also be obtained by using nitrogen gas instead of carbon dioxide gas.

### Example 4

5. Effect of Maintaining Enzyme Activity Contained in Koji Extract by Adjusting Carbon Dioxide Gas Pressure (2)

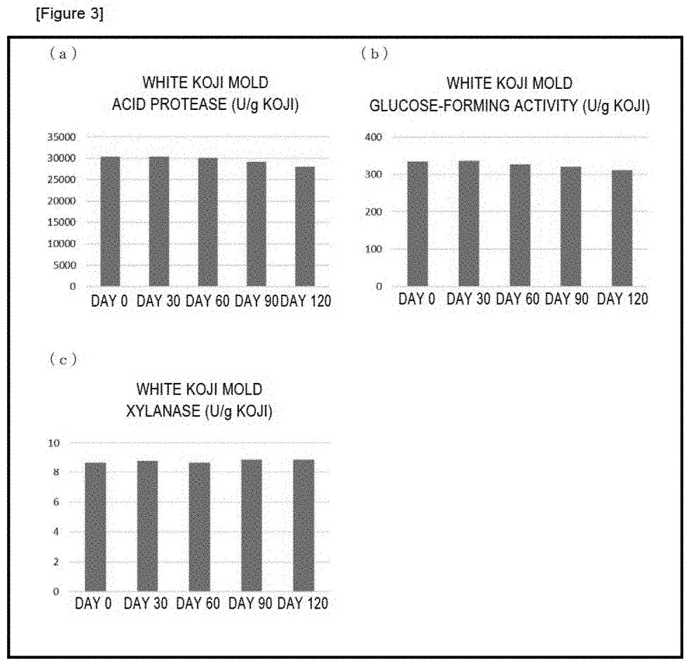

Rice koji obtained by propagating a white koji mold (Aspergillus kawachii) on rice was added at a ratio of 30 g per 100 mL of water, and the mixture was subjected to extraction under a condition of 30° C. for 3 hours. The supernatant was collected and aseptically filtered through a sterilization filter to obtain water extract of the koji. The enzyme titers of acid protease, glucose-forming activity (glucoamylase activity+α-glucosidase activity), and xylanase contained in the freshly obtained koji extract were measured as the enzyme activity on day 0. Carbon dioxide gas was injected under pressure into the water extract of the koji such that the carbon dioxide gas internal pressure in the container at 20° C. was 0.1 MPa, and with the extract a 100-mL aluminum can was filled to prepare a test sample (carbon dioxide gas internal pressure of 0.1 MPa). The carbon dioxide gas internal pressure in the container was confirmed by measuring the gas pressure of the water extract of the koji with which the can was filled to be stoppered immediately after carbonation. Furthermore, for comparison and as a control, a 100-mL aluminum can was directly filled with the water extract of the koji obtained in the same manner to prepare a control sample (carbon dioxide gas internal pressure of 0 MPa). These aluminum canned samples were allowed to stand in an environment of 4° C. for 30 days. 60 days, 90 days, and 120 days. The aluminum cans were opened at each number of days elapsed, and the enzyme titers of acid protease, glucose-forming activity, and xylanase contained in the water extract of the koji were measured. Results are shown in Table 11 and FIG. 3.

The enzyme titers of acid protease and glucose-forming activity (glucoamylase activity+α-glucosidase activity) were measured according to the method of the National Research. Institute of Brewing standard analysis method (solid koji; National Research Institute of Brewing, an independent administrative agency). In addition, for measurement of the enzyme titer of xylanase activity to hydrolyze a β1,4-glycosidic bond of xylan), the enzyme titer was determined with the amount of the enzyme that frees 1 mg of xylose per 60 minutes at 40° C. by the Somogyi-Nelson method defined as 1 unit. Specifically, a xylose-containing standard solution of 0 to 240 μL/mL was prepared, 0.5 mL of the standard solution was caused to develop color by the Somogyi-Nelson method, and a standard curve was prepared from the absorbance at 500 nm. On the other hand, 0.4 mL of a 1% xylan solution serving as a substrate was added to 0.1 of the water extract of the koji according to the present invention and reacted at 40° C. for 60 minutes, then 0.5 mL of the above was caused to develop color by the Somogyi-Nelson method, the absorbance at 500 nm was determined, and the free xylose concentration X (mg/tube) was determined from the standard curve. The enzyme titer of xylanase was obtained by calculating the free xylose concentration per g of the koji to be extracted from the free xylose concentration X.

TABLE 11

| Measurement item | | 0 days | 30 days | 60 days | 90 days | 120 days |
|---|---|---|---|---|---|---|
| Acid protease | No carbon dioxide gas | 30376.7 | 0 | 0 | 0 | 0 |
| white koji mold | 0.1 MPa | 30376.7 | 30360 | 30101 | 29111 | 27958.2 |
| (U/g koji) | Enzyme activity remaining | — | 99.90% | 99.10% | 95.80% | 92.00% |
| Glucose-forming | No carbon dioxide gas | 334.3 | 0 | 0 | 0 | 0 |
| activity/white koji | 0.1 MPa | 334.3 | 336 | 327 | 320 | 311 |
| mold (U/g koji) | Enzyme activity remaining | — | 100.50% | 97.80% | 95.70% | 93.00% |
| Xylanase | No carbon dioxide gas | 8.7 | 0 | 0 | 0 | 0 |
| white koji mold | 0.1 MPa | 8.7 | 8.8 | 8.7 | 8.9 | 8.9 |
| (U/g koji) | Enzyme activity remaining | — | 100.80% | 99.70% | 101.90% | 101.90% |

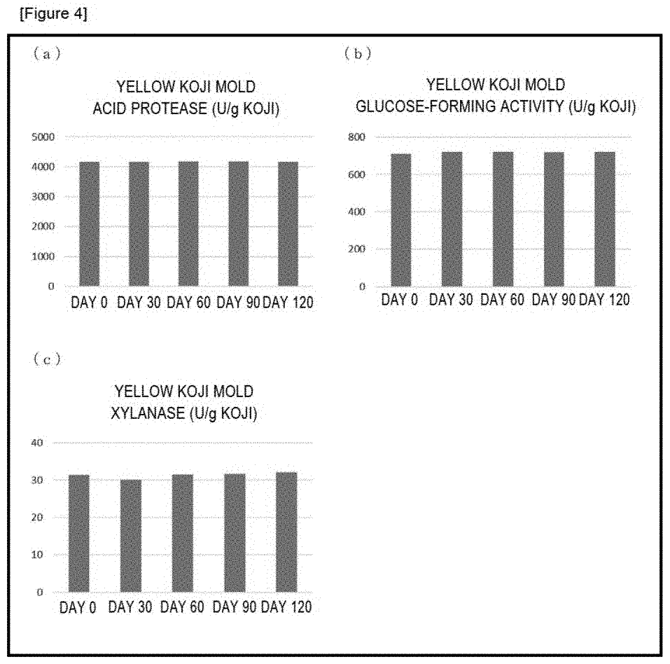

The water extract of the koji obtained using rice koji obtained by propagating a yellow koji mold (Aspergillus oryzae) on rice as the rice koji was also measured for each enzyme titer using the same conditions and methods as described above. Results are shown in Table 12 and FIG. 4.

TABLE 12

| Measurement item | | 0 days | 30 days | 60 days | 90 days | 120 days |
|---|---|---|---|---|---|---|
| Acid protease | No carbon dioxide gas | 4165.1 | 0 | 0 | 0 | 0 |
| yellow koji mold | 0.1 MPa | 4165.1 | 4170 | 4172 | 4188 | 4166 |
| (U/g koji) | Enzyme activity remaining | — | 100.10% | 100.20% | 100.50% | 100.00% |
| Glucose-forming | No carbon dioxide gas | 711.8 | 0 | 0 | 0 | 0 |
| activity/yellow | 0.1 MPa | 711.8 | 721 | 723 | 720 | 722 |
| koji mold | Enzyme activity | — | 101.30% | 101.60% | 101.20% | 101.40% |
| (U/g koji) | remaining | | | | | |
| Xylanase | No carbon dioxide gas | 31.3 | 0 | 0 | 0 | 0 |
| yellow koji | 0.1 MPa | 31.3 | 30 | 31.5 | 31.6 | 32.1 |
| mold (U/g koji) | Enzyme activity remaining | — | 95.80% | 100.60% | 100.90% | 102.50% |

As shown in FIGS. 3 and 4 and Tables 11 and 12, for the water extract of the koji into which carbon dioxide gas was injected under pressure in such a way as to provide 0.1 MPa, it was confirmed that even after preservation in an environment of 4° C. for 120 days, various enzymes remained in the water extract of the koji with an enzyme titer of more than 90%. At this time, for the water extract of the koji into which carbon dioxide gas was not injected under pressure, which was a comparative control, even in an environment of a preservation temperature of the sample of 4° C., the enzyme activity disappeared on day 30, and the enzyme titer was zero. in the present Example, carbon dioxide gas was injected under pressure into the water extract of the koji, but it has been confirmed that the same effect of maintaining the enzyme activity can also be obtained using nitrogen gas instead of carbon dioxide gas.

The present invention is not limited to the above-described embodiments or Examples, and those based on various design changes without departing from the scope of the present invention defined in the claims are also included in the technical scope.

1. A method for manufacturing packaged beverage in which the generation of old stink is suppressed, comprising a step of extraction to obtain koji extract by immersing a koji in a water-containing solvent, and a step of containing carbon dioxide gas in the koji extract or a beverage containing the koji extract such that a carbon dioxide gas internal pressure at 20° C. is 0.03 MPa or more.

2. The method for manufacturing packaged beverage in which the generation of old stink is suppressed according to claim 1, wherein the koji is at least one kind of koji selected from the group consisting of rice koji, barley koji, and tea koji.

3. The method for manufacturing packaged beverage in which the generation of old stink is suppressed according to claim 1, wherein the water-containing solvent is water or green tea beverage.

4. The method for manufacturing packaged beverage in which the generation of old stink is suppressed according to claim 2, wherein the water-containing solvent is water or green tea beverage.

5. A method for suppressing old stink of koji extract, comprising a step of containing carbon dioxide gas in the koji extract such that a carbon dioxide gas internal pressure at 20° C. is 0.03 MPa or more.

6. A method for maintaining an enzyme activity of koji extract, comprising a step of containing carbon dioxide gas or nitrogen gas in the koji extract so that an internal pressure of the carbon dioxide gas or nitrogen gas at 20° C. is 0.03 MPa or more.

7. The method for maintaining an enzyme activity of koji extract according to claim 6, wherein the internal pressure of the carbon dioxide gas or nitrogen gas is 0.1 MPa to 0.15 MPa.
